(19) United States
(12) Patent Application Publication
(10) Pub. No.: US 2022/0106166 A1
(43) Pub. Date: Apr. 7, 2022

(54) ROPELESS ELEVATOR WHEEL FORCE RELEASING SYSTEM

(71) Applicant: Otis Elevator Company, Farmington, CT (US)

(72) Inventors: Randy Roberts, Hebron, CT (US); Bruce Swaybill, Farmington, CT (US); Kiron Bhaskar, Farmington, CT (US); Brad Guilani, Woodstock Valley, CT (US)

(21) Appl. No.: 17/062,042

(22) Filed: Oct. 2, 2020

(51) Int. Cl. B66B 9/02; B66B 11/00; B66B 11/04

(52) U.S. Cl. CPC B66B 9/02; B66B 11/043; B66B 11/005

(57) ABSTRACT

According to an embodiment, an elevator system including: a beam climber system configured to move an elevator car through an elevator shaft by climbing a first guide beam that extends vertically through the elevator shaft, the first guide beam including a first surface and a second surface opposite the first surface, the beam climber system including: a first wheel in contact with the first surface; and a first electric motor configured to rotate the first wheel; and a wheel decompression system configured to move the first wheel away from the first guide rail.

### BACKGROUND

The subject matter disclosed herein relates generally to the field of elevator systems, and specifically to a method and apparatus for alleviating pressure on wheels of elevator car propulsion systems.

Elevator cars are conventionally operated by ropes and counterweights, which typically only allow one elevator car in an elevator shaft at a single time. Ropeless elevator systems may allow for more than one elevator car in the elevator shaft at a single time.

### BRIEF SUMMARY

According to an embodiment, an elevator system is provided. The elevator system including: a beam climber system configured to move an elevator car through an elevator shaft by climbing a first guide beam that extends vertically through the elevator shaft, the first guide beam including a first surface and a second surface opposite the first surface, the beam climber system including: a first wheel in contact with the first surface; and a first electric motor configured to rotate the first wheel; and a wheel decompression system configured to move the first wheel away from the first guide rail.

In addition to one or more of the features described herein, or as an alternative, further embodiments may include that the wheel decompression system includes: a first backup wheel operably connected to the first wheel such that when the first backup wheel moves away from the first guide beam the first wheel also moves away; and a first separating cam located between the first guide beam and a first guide rail of the elevator system, wherein the first separating cam is wedge shaped and configured to move the first backup wheel and the first wheel away from the first guide rail when the first backup wheel rolls onto the separating cam.

In addition to one or more of the features described herein, or as an alternative, further embodiments may include: a first axle, wherein the first electric motor is located on the first axle, and wherein the first backup wheel is located on the first axle.

In addition to one or more of the features described herein, or as an alternative, further embodiments may include that the first separating cam is fixed and wedge shaped.

In addition to one or more of the features described herein, or as an alternative, further embodiments may include that the first separating cam further includes a first end and a second end opposite the first end, the first end having a first thickness and the second end having a second thickness, wherein the second thickness is greater than the first thickness.

In addition to one or more of the features described herein, or as an alternative, further embodiments may include that the first backup wheel rolls onto the separating cam at the first end.

In addition to one or more of the features described herein, or as an alternative, further embodiments may include that the first separating cam is wedge shaped.

In addition to one or more of the features described herein, or as an alternative, further embodiments may include that the first separating cam is adjustable to open and close, and wherein the first separating cam transforms into a wedge shape when opened.

In addition to one or more of the features described herein, or as an alternative, further embodiments may include that the first separating cam further includes a first end and a second end opposite the first end, wherein the first separating cam pivots at the first end to open.

In addition to one or more of the features described herein, or as an alternative, further embodiments may include that the beam climber system further includes: a first compression mechanism configured to compress the first wheel against the first surface.

In addition to one or more of the features described herein, or as an alternative, further embodiments may include that the wheel decompression system includes: a first expansion wheel operably connected to the first wheel such that when the first expansion wheel moves away from the first guide beam the first wheel also moves away, the first expansion wheel being configured to expand to compress the compression mechanism and push the first wheel away from the first guide beam to relieve pressure on the first wheel.

In addition to one or more of the features described herein, or as an alternative, further embodiments may include: a first axle, wherein the first electric motor is located on the first axle, and wherein the first expansion wheel is located on the first axle.

In addition to one or more of the features described herein, or as an alternative, further embodiments may include that the first expansion wheel further includes: a force actuator; and one or more drum wedges, wherein the force actuator is configured to actuate to expand the drum wedges to push the first expansion wheel away from the first guide beam.

In addition to one or more of the features described herein, or as an alternative, further embodiments may include that the first expansion wheel further includes: an engagement sensor configured to detect when the drum wedges are engaged with the first guide beam.

In addition to one or more of the features described herein, or as an alternative, further embodiments may include that the wheel decompression system includes: a first linear actuator operably connected to the first wheel such that when the linear actuator moves away from the first guide beam the first wheel also moves away, the first linear actuator being configured to expand to compress the compression mechanism and push the first wheel away from the first guide beam to relieve pressure on the first wheel.

In addition to one or more of the features described herein, or as an alternative, further embodiments may include that the first linear actuator further includes: a first control arm, wherein the first linear actuator is configured to actuate to expand the first control arm to push the first linear actuator away from the first guide beam.

In addition to one or more of the features described herein, or as an alternative, further embodiments may include that the wheel decompression system further includes: a first pivot arm including a first end, a second end located opposite the first end, and an intermediate point located between the first end and the second end; and a first support bracket operably connected to the first pivot arm at the first end, the first pivot arm being operably connected to the elevator car at the second end, wherein the first pivot arm is operably connected to the first wheel at the intermediate point, and wherein the first pivot arm is configured to pivot about the second end.

Technical effects of embodiments of the present disclosure include lifting one or more wheels of a beam climber system away from a guide beam to relieve pressure on the one or more wheels utilizing a wheel decompression system configured to move the wheels away from the guide rails.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system with a beam climber system, in accordance with an embodiment of the disclosure;

FIG. 2 illustrates a front view of a wheel decompression system, in accordance with an embodiment of the disclosure;

FIG. 3 illustrates a side view of the wheel decompression system of FIG. 2, in accordance with an embodiment of the disclosure;

FIG. 4 illustrates a top view of the wheel decompression system of FIG. 2, in accordance with an embodiment of the disclosure;

FIG. 5 illustrates a top view of the wheel decompression system of FIG. 2, in accordance with an embodiment of the disclosure;

FIG. 6 illustrates a front view of a wheel decompression system, in accordance with an embodiment of the disclosure;

FIG. 7 illustrates a side view of the wheel decompression system of FIG. 6, in accordance with an embodiment of the disclosure;

FIG. 8 illustrates a top view of the wheel decompression system of FIG. 6, in accordance with an embodiment of the disclosure;

FIG. 9 illustrates a top view of the wheel decompression system of FIG. 6, in accordance with an embodiment of the disclosure;

FIG. 10 illustrates a side view of an expansion wheel of a wheel decompression system, in accordance with an embodiment of the disclosure;

FIG. 11 illustrates a top view of the wheel decompression system of FIG. 10, in accordance with an embodiment of the disclosure;

FIG. 12 illustrates a side view of a wheel decompression system, in accordance with an embodiment of the disclosure;

FIG. 13 illustrates a side view of the wheel decompression system of FIG. 12, in accordance with an embodiment of the disclosure; and

FIG. 14 illustrates a side view of the wheel decompression system of FIG. 12, in accordance with an embodiment of the disclosure.

### DETAILED DESCRIPTION

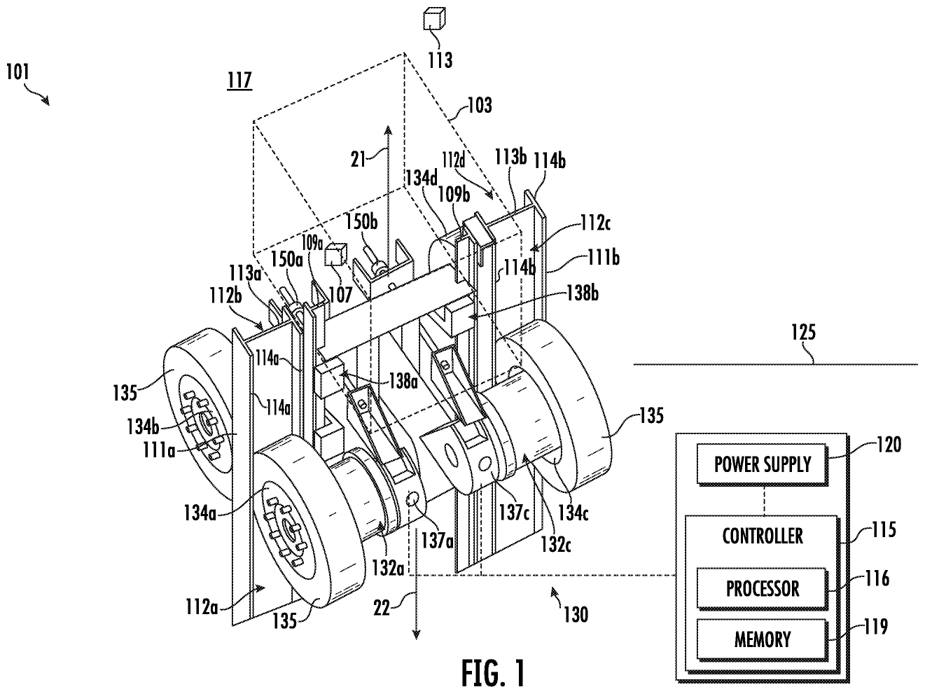

FIG. 1 is a perspective view of an elevator system 101 including an elevator car 103, a beam climber system 130, a controller 115, and a power source 120. Although illustrated in FIG. 1 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 1 as separate from the beam climber system 130, the embodiments described herein may be applicable to a power source 120 included in the beam climber system 130 (i.e., moving through the elevator shaft 117 with the beam climber system 130) and may also be applicable to a power source located off of the beam climber system 130 (i.e., remotely connected to the beam climber system 130 and stationary relative to the beam climber system 130).

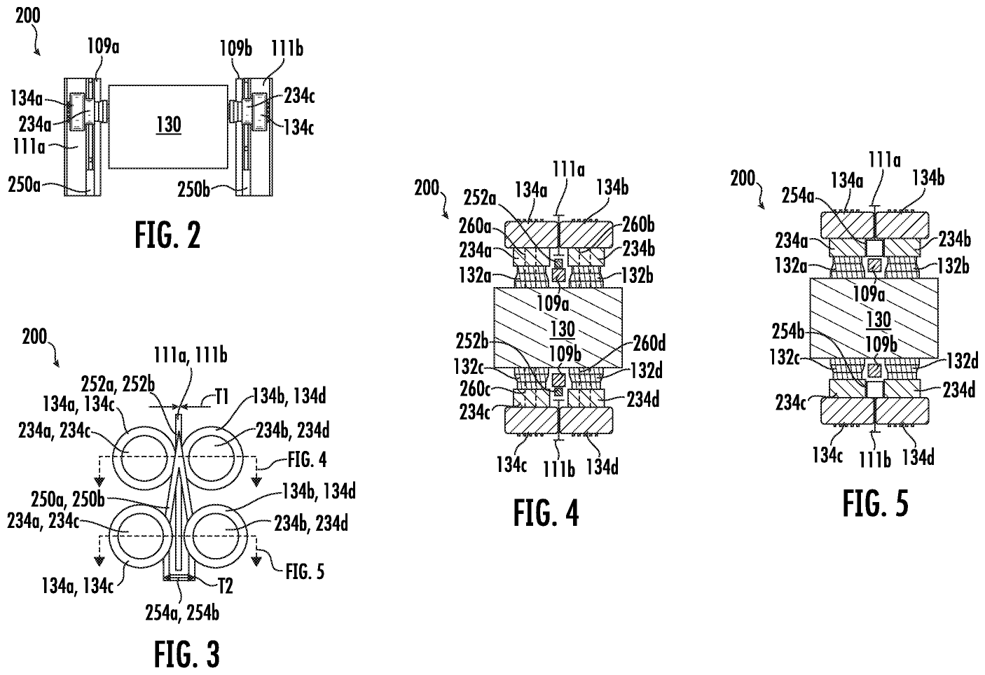

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132c. The electric motors 132a, 132c are configured to move the beam climber system 130 within the elevator shaft 117 by rotating one or more wheels 134a, 134b that are pressed against a guide beam 111a, 111b. In an embodiment, the guide beams 111a, 111b are I-beams. It is understood that while an I-beam is illustrated, any beam or similar structure may be utilized with the embodiment described herein. Friction between the wheels 134a, 134b, 134c, 134d driven by the electric motors 132a, 132c allows the wheels 134a, 134b, 134c, 134d to climb up 21 and down 22 the guide beams 111a, 111b. The guide beam extends vertically through the elevator shaft 117. It is understood that while two guide beams 111a, 111b are illustrated, the embodiments disclosed herein may be utilized with one or more guide beams. It is also understood that while two electric motors 132a, 132c are illustrated visible, the embodiments disclosed herein may be applicable to beam climber systems 130 having one or more electric motors. For example, the beam climber system 130 may have one electric motor for each of the four wheels 134a, 134b, 134c, 134d (e.g., see FIG. 2, which illustrates a first electric motor 132a, a second electric motor 132b, a third electric motor 132c, and a fourth electric motor 132d). The electrical motors 132a, 132c may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 103).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a. The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 101 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the shaft 117, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 103.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b. The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 101 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132c is configured to rotate the third wheel 134c to climb up 21 or down 22 the second guide beam 111b. The second electric motor 132c may also include a third motor brake 137c to slow and stop rotation of the third motor 132c. The third motor brake 137c may be mechanically connected to the third motor 132c. The third motor brake 137c may be a clutch system, a disc brake system, drum brake system, a brake on a rotor of the second electric motor 132c, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 103.

The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130. In embodiment, the controller 115 controls on-board motion control of the beam climber system 115 (e.g., a supervisory function above the individual motor controllers).

The power supply 120 for the elevator system 101 may be any power source, including a power grid and/or battery power which, in combination with other components, is supplied to the beam climber system 130. In one embodiment, power source 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

As aforementioned, the first wheel 134a and the second wheel 134b are being compressed against the first guide beam 111a by the first compression mechanism 150a and the third wheel 134c and the fourth wheel 134d are being compressed against the second guide beam by the second compression mechanism. This compression is required such that the first wheel 134a and second wheel 134b, maintain traction with the first guide beam 11a and the third wheel 134c and the fourth wheel 134d maintain traction with the second guide beam. This compression is fairly high to support the weight of both the elevator car 103 and the beam climber system 130. This high compression may lead to warping (also known as flat spotting) of the wheels 134a, 134b, 134c, 134d or tires 135 if the beam climber 130 and elevator car 103 are not being utilized for long durations of time. The embodiments disclosed herein seek to address this warpage by alleviating the compression on the wheels 134a, 134b, 134c, 134d and tires 135 utilizing a wheel decompression system configured to move the wheels away from the guide rails.

Referring now to FIG. 2 with continued reference to FIG. 1, a wheel decompression system 200 is illustrated, in accordance with an embodiment of the present disclosure. The wheel decompression system 200 is composed of a first separating cam 250a and a second separating cam 250b. The first separating cam 250a is located between the first guide beam 111a and the first guide rail 109a. The second separating cam 250b is located between the second guide beam 111b and the second guide rail 109b. It is understood that while the embodiments disclosed herein illustrate separating cams 250a, 250b in the aforementioned locations, the embodiments disclosed herein may also be applicable to separating cams 250a, 250b in other functional locations such as between the guide beam 111a, 111b and the elevator car 103 and/or the guide rail 109a, 109b and wall of the elevator shaft 118. When the beam climber system 130 is not required to transport the elevator car 103 and/or may be inoperable for greater than a selected period of time, the beam climber system 130 may move itself to the wheel decompression system 200 and the wheel decompression system 200 is configured to lift the wheels 134a, 134b, 134c, 134d away from the guide beams 111a, 111b, while the beam climber system 130 is held in place. The wheel decompression system 200 accomplishes this through the use of the separating cams 250a, 250b and a first backup wheel 234a, a second backup wheel (see FIGS. 4 and 5), a third backup 234c, and a fourth back up wheel 134d (see FIGS. 4 and 5). The wheel decompression system 200 may be located at a top of an elevator shaft 117, at the bottom of the elevator shaft 117, in the middle of the elevator shaft 117, in a parking area for elevator cars 103 and/or beam climber systems 130, a transfer carriage/vehicle for elevator cars 103 and/or beam climber systems 130, and/or in a transfer station for elevator cars 103 and/or beam climber systems 130.

Referring now to FIGS. 3-5 with continued reference to FIGS. 1 and 2, the wheel decompression system 200 is illustrated, in accordance with an embodiment of the present disclosure. As illustrated in FIG. 3, the first separating cam 250a and the second separating cam 250b are fixed and wedge shaped. The separating cam 250a, 250b may also be diamond shaped. As aforementioned, the first separating cam 250a is located between the first guide beam 111a and the first guide rail 109a. The second separating cam 250b is located between the second guide beam 111b and the second guide rail 109b.

The first backup wheel 234a is operably connected to the first wheel 134a such that when the first backup wheel 234a moves away from the first guide beam 111a the first wheel 134a also moves away. The second backup wheel 234b is operably connected to the second wheel 134b such that when the second backup wheel 234b moves away from the first guide beam 111a the second wheel 134b also moves away.

The first wheel 134a, the first electric motor 132a, and the first backup wheel 234a are located on a first axle 260a. The second wheel 134b, the second electric motor 132b, and the second backup wheel 234b are located on a second axle 260b. The first separating cam 250a includes a first end 252a and a second end 254a opposite the first end 252a. The first end 252a has a first thickness T1 and the second end 254a has a second thickness T2. The second thickness T2 is greater than the first thickness T1 such that the first separating cam 250a is wedge shaped or diamond shaped. When the controller 115 determines that decompression of the wheels 134a, 134b is required the controller 115 will command the beam climber system 130 to roll onto the first end 252a of the separating cam 250a. As the first backup wheel 234a and the second backup wheel 234b roll from the first end 252 to the second end 254a, the first backup wheel 234a and the second backup wheel 234b will slowly increase in separation as the first separating cam 250a pushes them apart and compresses the first compression mechanism 150a. It should be noted that if the first compression mechanism 150a is an actuated device providing a variable amount of compression using an actuated compression force, the first compression mechanism 150a may have to relieve the actuated compression force for the first separating came to push the first backup wheel 234a and the second backup wheel 234b apart. Since the first wheel 134a and the first backup wheel 234a are located on the same axle (i.e., the first axle 260a) and the second wheel 134b and the second backup wheel 234b are located on the same axle (i.e., the second axle 260b) when the first backup wheel 234a separates from the second backup wheel 234b then the first wheel 134a and the second wheel 134b will also separate and lift away from the first guide beam 111a.

The third backup wheel 234c is operably connected to the third wheel 134c such that when the third backup wheel 234c moves away from the second guide beam 111b the third wheel 134c also moves away. The fourth backup wheel 234d is operably connected to the fourth wheel 134d such that when the fourth backup wheel 234d moves away from the second guide beam 111b the fourth wheel 134d also moves away.

The third wheel 134c, the third electric motor 132c, and the third backup wheel 234c are located on a third axle 260c. The fourth wheel 134d, the fourth electric motor 132d, and the fourth backup wheel 234d are located on a fourth axle 260d. The second separating cam 250b includes a first end 252b and a second end 254b opposite the first end 252b. The first end 252b has a first thickness T1 and the second end 254b has a second thickness T2. The second thickness T2 is greater than the first thickness T1 such that the second separating cam 250b is wedge shaped or diamond shaped. When the controller 115 determines that decompression of the wheels 134a, 134b is required the controller 115 will command the beam climber system 130 to roll onto the first end 252b of the separating cam 250a. As the third backup wheel 234c and the fourth backup wheel 234d roll from the first end 252 to the second end 254b, the third backup wheel 234c and the fourth backup wheel 234d will slowly increase in separation as the second separating cam 250b pushes them apart and compresses the second compression mechanism 150b. It should be noted that if the second compression mechanism 150b is an actuated device providing a variable amount of compression using an actuated compression force, the second compression mechanism 150b may have to relieve the actuated compression force for the first separating came to push the third backup wheel 234c and the fourth backup wheel 234d apart. Since the third wheel 134c and the third backup wheel 234c are located on the same axle (i.e., the third axle 260c) and the fourth wheel 134d and the fourth backup wheel 234d are located on the same axle (i.e., the fourth axle 260d) when the third backup wheel 234c separates from the fourth backup wheel 234d then the third wheel 134c and the fourth wheel 134d will also separate and lift away from the second guide beam 111b.

Also, advantageously, the embodiments disclosed herein save electrical energy by avoiding the need to keep the beam climber system 130 in constant operation to avoid flat spots in the wheels 134a, 134b, 134c, 134d and/or tires 135.

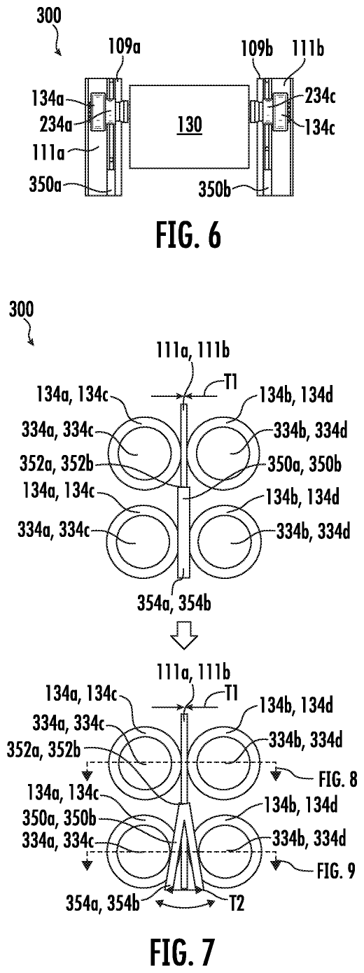

Referring now to FIG. 6 with continued reference to FIG. 1, a wheel decompression system 300 is illustrated, in accordance with an embodiment of the present disclosure. The wheel decompression system 300 is composed of a first separating cam 350a and a second separating cam 350b. The first separating cam 350a is located between the first guide beam 111a and the first guide rail 109a. The second separating cam 350b is located between the second guide beam 111b and the second guide rail 109b. It is understood that while the embodiments disclosed herein illustrate separating cams 350a, 350b in the aforementioned locations, the embodiments disclosed herein may also be applicable to separating cams 250a, 250b in other functional locations such as between the guide beam 111a, 111b and the elevator car 103 and/or the guide rail 109a, 109b and wall of the elevator shaft 118. When the beam climber system 130 is not required to transport the elevator car 103 and/o may be inoperable for greater than a selected period of time, the beam climber system 130 may move itself to the wheel decompression system 300 and the wheel decompression system 300 is configured to lift the wheels 134a, 134b, 134c, 134d away from the guide beams 111a, 111b, while the beam climber system 130 is held in place. The wheel decompression system 300 accomplishes this through the use of the separating cams 350a, 350b and a first backup wheel 234a, a second backup wheel (see FIG. 7), a third backup 234c, and a fourth back up wheel 134d (see FIG. 7). The wheel decompression system 300 may be located at atop of an elevator shaft 117, at the bottom of the elevator shaft 117, in the middle of the elevator shaft 117, in a parking area for elevator cars 103 and/or beam climber systems 130, a transfer carriage/vehicle for elevator cars 103 and/or beam climber systems 130, and/or in a transfer station for elevator cars 103 and/or beam climber systems 130.

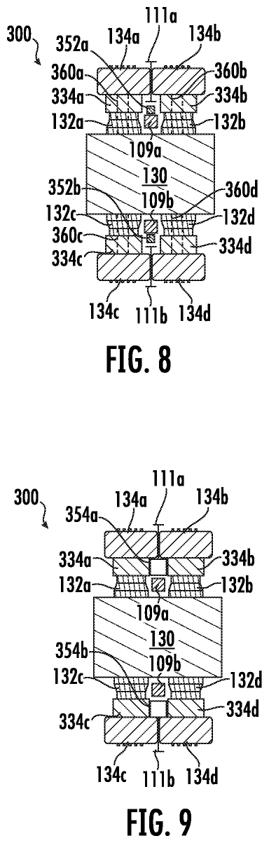

Referring now to FIGS. 7-9, with continued reference to the previous FIGS., the wheel decompression system 300 is illustrated, in accordance with an embodiment of the disclosure. As illustrated in FIG. 7-9, the first separating cam 350a and the second separating cam 350b are not fixed, as opposed to the wheel decompression system 200 discussed above. Rather, as illustrated in FIG. 7-9, the first separating cam 350a and the second separating cam 350b are adjustable to open and close, which transformed each separating cam 350a, 350b into a wedge shape or diamond shape when open. The first separating cam 350a may pivot at the first end 352a to open and the second separating cam 350b may pivot at the first end 352b to open. The separating cams 350a, 350b may remain closed to allow the elevator car 130 to move right past them during normal operation but then open when the elevator car 130 requires decompression of the wheels 134a, 134b, 134c, 134d and the elevator car 130 is properly positioned at the separating cams 350a, 350b. The separating cams 350a, 350b may utilize actuators to open and close. The actuators may be non-backdrivable actuators, such as, for example, ball screw actuators. As aforementioned, the first separating cam 350a is located between the first guide beam 111a and the first guide rail 109a. The second separating cam 350b is located between the second guide beam 111b and the second guide rail 109b.

The first backup wheel 334a is operably connected to the first wheel 134a such that when the first backup wheel 334a moves away from the first guide beam 111a the first wheel 134a also moves away. The second backup wheel 334b is operably connected to the second wheel 134b such that when the second backup wheel 334b moves away from the first guide beam 111a the second wheel 134b also moves away.

The first wheel 134a, the first electric motor 132a, and the first backup wheel 334a are located on a first axle 360a. The second wheel 134b, the second electric motor 132b, and the second backup wheel 334b are located on a second axle 360b. The second separating cam 350b includes a first end 352a and a second end 354a opposite the first end 352a. The first end 352a has a first thickness T1 and the second end 354a has a second thickness T2. The second thickness T2 is greater than the first thickness T1 such that the second separating cam 350b is wedge shaped when the second separating cam 350b is opened. When the controller 115 determines that decompression of the wheels 134a, 134b is required the controller 115 will command the beam climber system 130 to roll onto the first end 352a of the separating cam 350a. As the first backup wheel 334a and the second backup wheel 334b roll from the first end 352 to the second end 354a, the first backup wheel 334a and the second backup wheel 334b will slowly increase in separation as the second separating cam 350b pushes them apart and compresses the first compression mechanism150a. It should be noted that if the first compression mechanism 150a is an actuated device providing a variable amount of compression using an actuated compression force, the first compression mechanism 150a may have to relieve the actuated compression force for the first separating came to push the first backup wheel 234a and the second backup wheel 234b apart. Since the first wheel 134a and the first backup wheel 334a are located on the same axle (i.e., the first axle 360a) and the second wheel 134b and the second backup wheel 334b are located on the same axle (i.e., the second axle 360b) when the first backup wheel 334a separates from the second backup wheel 334b then the first wheel 134a and the second wheel 134b will also separate and lift away from the first guide beam 111a.

The third backup wheel 334c is operably connected to the third wheel 134c such that when the third backup wheel 334c moves away from the second guide beam 111b the third wheel 134c also moves away. The fourth backup wheel 334d is operably connected to the fourth wheel 134d such that when the fourth backup wheel 334d moves away from the second guide beam 111b the fourth wheel 134d also moves away.

The third wheel 134c, the third electric motor 132c, and the third backup wheel 334c are located on a third axle 360c. The fourth wheel 134d, the fourth electric motor 132d, and the fourth backup wheel 334d are located on a fourth axle 360d. The second separating cam 350b includes a first end 352b and a second end 354b opposite the first end 352b. The first end 352b has a first thickness T1 and the second end 354b has a second thickness T2. The second thickness T2 is greater than the first thickness T1 such that the second separating cam 350b is wedge shaped when the second separating cam 350b is opened. When the controller 115 determines that decompression of the wheels 134a, 134b is required the controller 115 will command the beam climber system 130 to roll onto the first end 352b of the separating cam 350a. As the third backup wheel 334c and the fourth backup wheel 334d roll from the first end 352 to the second end 354b, the third backup wheel 334c and the fourth backup wheel 334d will slowly increase in separation as the second separating cam 350b pushes them apart and compresses the second compression mechanism150b. It should be noted that if the second compression mechanism 150b is an actuated device providing a variable amount of compression using an actuated compression force, the second compression mechanism 150b may have to relieve the actuated compression force for the first separating came to push the third backup wheel 234c and the fourth backup wheel 234d apart. Since the third wheel 134c and the third backup wheel 334c are located on the same axle (i.e., the third axle 360c) and the fourth wheel 134d and the fourth backup wheel 334d are located on the same axle (i.e., the fourth axle 360d) when the third backup wheel 334c separates from the fourth backup wheel 334d then the third wheel 134c and the fourth wheel 134d will also separate and lift away from the second guide beam 111b.

Also, advantageously, the embodiments disclosed herein save electrical energy by avoiding the need to keep the beam climber system 130 in constant operation to avoid flat spots in the wheels 134a, 134b, 134c, 134d and/or tires 135.

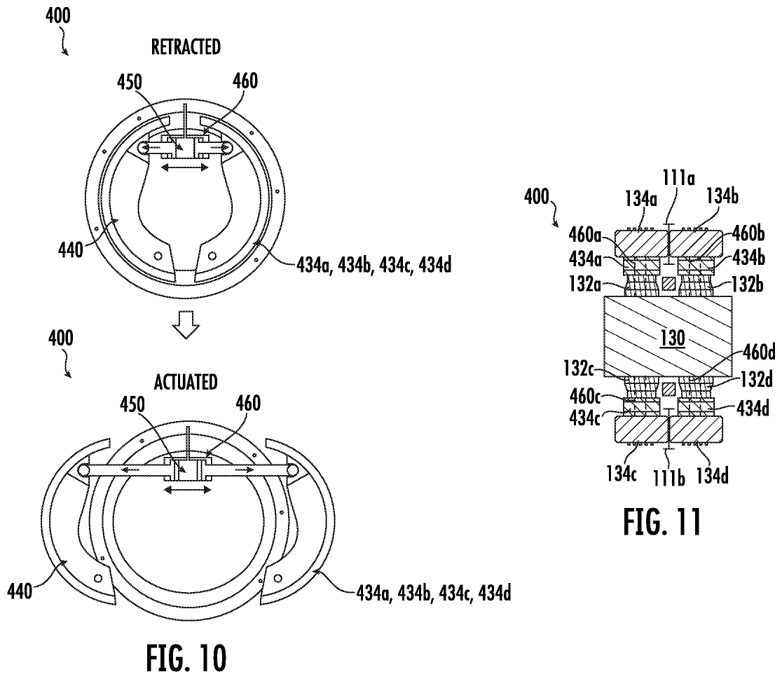

Referring now to FIGS. 10-11, with continued reference to FIG. 1, a wheel decompression system 400 is illustrated in accordance with an embodiment of the present disclosure. The wheel decompression system 400 includes one or more expansion wheels 434a, 434b, 434c, 434d configured to expand and push against the guide beam 111a, 111b to lift the wheels 134a, 134b, 134c, 134d away from the guide beam 111a, 111b.

The first expansion wheel 434a is operably connected to the first wheel 134a such that when the first expansion wheel 434a moves away from the first guide beam 111a the first wheel 134a also moves away. The second expansion wheel 434b is operably connected to the second wheel 134b such that when the second expansion wheel 434b moves away from the first guide beam 111a the second wheel 134b also moves away. The third expansion wheel 434c is operably connected to the third wheel 134c such that when the third expansion wheel 434c moves away from the second guide beam 111b the third wheel 134c also moves away. The fourth expansion wheel 434d is operably connected to the fourth wheel 134d such that when the fourth expansion wheel 434d moves away from the second guide beam 111b the fourth wheel 134d also moves away.

The first wheel 134a, the first electric motor 132a, and the first expansion wheel 434a are located on a first axle 460a. The second wheel 134b, the second electric motor 132b, and the second expansion wheel 434b are located on a second axle 360b. The third wheel 134c, the third electric motor 132c, and the third expansion wheel 434c are located on a third axle 360c. The fourth wheel 134d, the fourth electric motor 132d, and the fourth expansion wheel 434d are located on a fourth axle 360d.

The first expansion wheel 434a is configured to expand to compress the compression mechanism 150a and push the first wheel 134a away from the first guide beam 111a to relieve the pressure from the first wheel 134a. The first expansion wheel 434a includes a force actuator 450, an engagement sensor 460, and drum wedges 440. The force actuator 450 is configured to actuate to expand the drum wedges 440 to push the first expansion wheel 434a away from the first guide beam 111a. The force actuator 450 is configured to actuate to contract the drum wedges 440 to move the first expansion wheel 434a towards the first guide beam 111a. The force actuator 450 may be a non-backdrivable actuators, such as, for example, a ball screw actuator. The force actuator 450 may be configured to slowly expand as the elevator car 103 approaches a stopping point to help slow the elevator car 103 or the force actuator 450 may wait for the elevator car 103 to stop at the stopping point and then expand. The engagement sensor 460 is configured to detect when the drum wedges 440 are engaged with the first guide beam 111a. Since the first wheel 134a and the first expansion wheel 434a are located on the same axle (i.e., the first axle 460a) when the first expansion wheel 434a expands then the first wheel 134a will lift away from the first guide beam 111a.

The second expansion wheel 434b is configured to expand to compress the compression mechanism 150a and push the second wheel 134b away from the first guide beam 111a to relieve the pressure from the second wheel 134b. The second expansion wheel 434b includes a force actuator 450, an engagement sensor 460, and drum wedges 440. The force actuator 450 is configured to actuate to expand the drum wedges 440 to push the second expansion wheel 434b away from the first guide beam 111a. The force actuator 450 is configured to actuate to contract the drum wedges 440 to move the second expansion wheel 434b towards the first guide beam 111a. The force actuator 450 may be a non-backdrivable actuators, such as, for example, a ball screw actuator. The force actuator 450 may be configured to slowly expand as the elevator car 103 approaches a stopping point to help slow the elevator car 103 or the force actuator 450 may wait for the elevator car 103 to stop at the stopping point and then expand. The engagement sensor 460 is configured to detect when the drum wedges 440 are engaged with the first guide beam 111a. Since the second wheel 134b and the second expansion wheel 434b are located on the same axle (i.e., the first axle 460a) when the second expansion wheel 434b expands then the second wheel 134b will lift away from the first guide beam 111a.

The third expansion wheel 434c is configured to expand to compress the compression mechanism 150a and push the third wheel 134c away from the second guide beam 111b to relieve the pressure from the third wheel 134c. The third expansion wheel 434c includes a force actuator 450, an engagement sensor 460, and drum wedges 440. The force actuator 450 is configured to actuate to expand the drum wedges 440 to push the third expansion wheel 434c away from the second guide beam 111b. The force actuator 450 is configured to actuate to contract the drum wedges 440 to move the third expansion wheel 434c towards the second guide beam 111b. The engagement sensor 460 is configured to detect when the drum wedges 440 are engaged with the second guide beam 111b. Since the third wheel 134c and the third expansion wheel 434c are located on the same axle (i.e., the first axle 460a) when the third expansion wheel 434c expands then the third wheel 134c will lift away from the second guide beam 111b.

The fourth expansion wheel 434d is configured to expand to compress the compression mechanism 150a and push the fourth wheel 134d away from the second guide beam 111b to relieve the pressure from the fourth wheel 134d. The fourth expansion wheel 434d includes a force actuator 450, an engagement sensor 460, and drum wedges 440. The force actuator 450 is configured to actuate to expand the drum wedges 440 to push the fourth expansion wheel 434d away from the second guide beam 111b. The force actuator 450 is configured to actuate to contract the drum wedges 440 to move the fourth expansion wheel 434d towards the second guide beam 111b. The engagement sensor 460 is configured to detect when the drum wedges 440 are engaged with the second guide beam 111b. Since the fourth wheel 134d and the fourth expansion wheel 434d are located on the same axle (i.e., the first axle 460a) when the fourth expansion wheel 434d expands then the fourth wheel 134d will lift away from the second guide beam 111b.

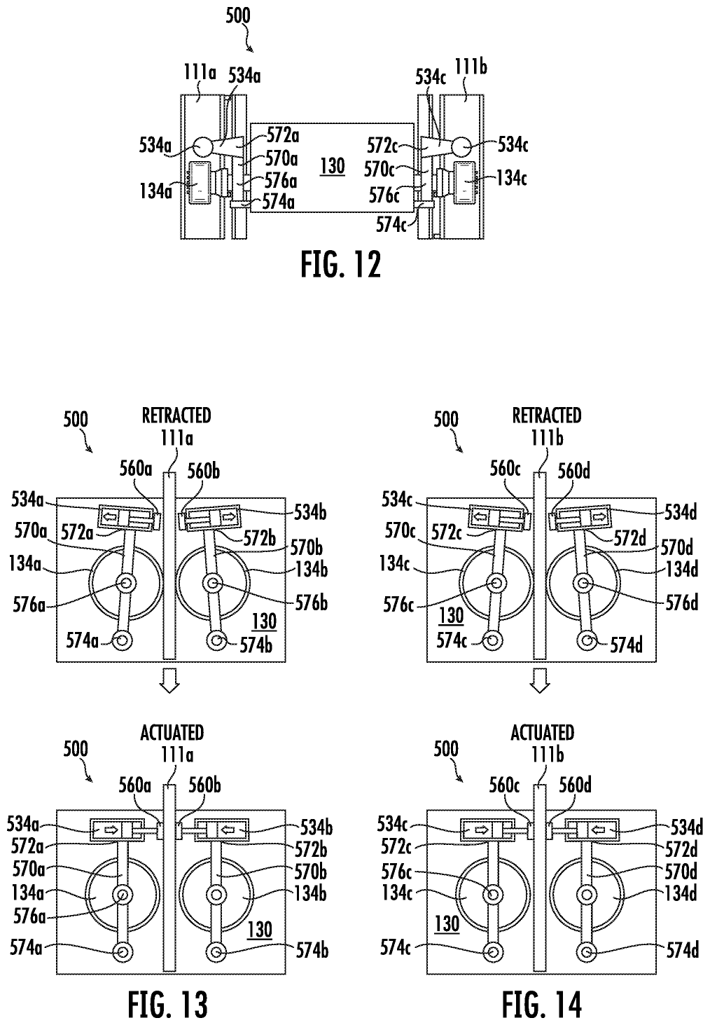

Referring now to FIGS. 12-14, with continued reference to FIG. 1, a wheel decompression system 500 is illustrated in accordance with an embodiment of the present disclosure. The wheel decompression system 500 includes one or more linear actuators 534a, 534b, 534c, 534d configured to expand and push against the guide beam 111a, 111b to lift the wheels 134a, 134b, 134c, 134d away from the guide beam 111a, 111b.

The first linear actuator 534a is configured to expand to compress the compression mechanism 150a and push the first wheel 134a away from the first guide beam 111a to relieve the pressure from the first wheel 134a. The first linear actuator 534a includes a first support bracket 536a, and a first control arm 560a. The first linear actuator 534 is configured to actuate to expand the first control arm 560a to push the first linear actuator 534a away from the first guide beam 111a. The first linear actuator 534a is configured to actuate to contract the first control arm 560a to move the first linear actuator 534a towards the first guide beam 111a.

The wheel decompression system 500 further comprises a first pivot arm 570a. The first pivot arm 570a includes a first end 572a, a second end 574a located opposite the first end 572a, and an intermediate point 576a located between the first end 572a and the second end 574a. The first support bracket 536a is operably connected to the first pivot arm 570a at the first end 572a. The first pivot arm 570a is operably connected to the elevator car 103 at the second end 574a. The first pivot arm 570a may be configured to pivot about or around the second end 574a. The first pivot arm 570a is operably connected to the first wheel 134a at the intermediate point 576a.

Since the first wheel 134a and the first linear actuator 534a are operably connected when the first linear actuator 534a expands then the first wheel 134a will lift away from the first guide beam 111a as the first pivot arm 570a pivots at the second end 574a.

The second linear actuator 534b is configured to expand to compress the compression mechanism 150b and push the second wheel 134b away from the second guide beam 111b to relieve the pressure from the second wheel 134b. The second linear actuator 534b includes one or more second support brackets 536b, and a second control arm 560b. The second linear actuator 534 is configured to actuate to expand the second control arm 560b to push the second linear actuator 534b away from the first guide beam 111a. The second linear actuator 534b is configured to actuate to contract the second control arm 560b to move the second linear actuator 534b towards the first guide beam 111a.

The wheel decompression system 500 further comprises a second pivot arm 570b. The second pivot arm 570b includes a first end 572b, a second end 574b located opposite the first end 572b, and an intermediate point 576b located between the first end 572b and the second end 574b. The second support bracket 536b is operably connected to the second pivot arm 570b at the first end 572b. The second pivot arm 570b is operably connected to the elevator car 103 at the second end 574b. The second pivot arm 570b may be configured to pivot about or around the second end 574b. The second pivot arm 570b is operably connected to the second wheel 134b at the intermediate point 576b.

Since the second wheel 134b and the second linear actuator 534b are operably connected when the second linear actuator 534b expands then the second wheel 134b will lift away from the first guide beam 111a as the second pivot arm 570b pivots at the second end 574b.

The third linear actuator 534c is configured to expand to compress the compression mechanism 150c and push the third wheel 134c away from the second guide beam 111b to relieve the pressure from the third wheel 134c. The third linear actuator 534c includes one or more third support brackets 536c, and a third control arm 560c. The third linear actuator 534 is configured to actuate to expand the third control arm 560c to push the third linear actuator 534c away from the second guide beam 111b. The third linear actuator 534c is configured to actuate to contract the third control arm 560c to move the third linear actuator 534c towards the second guide beam 111b.

The wheel decompression system 500 further comprises a third pivot arm 570c. The third pivot arm 570c includes a first end 572c, a second end 574c located opposite the first end 572c, and an intermediate point 576c located between the first end 572c and the second end 574c. The second support bracket 536b is operably connected to the third pivot arm 570c at the first end 572c. The third pivot arm 570c is operably connected to the elevator car 103 at the second end 574c. The third pivot arm 570c may be configured to pivot about or around the second end 574c. The third pivot arm 570c is operably connected to the third wheel 134c at the intermediate point 576c.

Since the third wheel 134c and the third linear actuator 534c are operably connected when the third linear actuator 534c expands then the third wheel 134c will lift away from the second guide beam 111b as the third pivot arm 570c pivots at the second end 574c.

The fourth linear actuator 534d is configured to expand to compress the compression mechanism 150d and push the fourth wheel 134d away from the second guide beam 111b to relieve the pressure from the fourth wheel 134d. The fourth linear actuator 534d includes one or more fourth support brackets 536d, and a fourth control arm 560d. The fourth linear actuator 534 is configured to actuate to expand the fourth control arm 560d to push the fourth linear actuator 534d away from the second guide beam 111b. The fourth linear actuator 534d is configured to actuate to contract the fourth control arm 560d to move the fourth linear actuator 534d towards the second guide beam 111b.

The wheel decompression system 500 further comprises a fourth pivot arm 570d. The fourth pivot arm 570d includes a first end 572d, a second end 574d located opposite the first end 572d, and an intermediate point 576d located between the first end 572d and the second end 574d. The second support bracket 536b is operably connected to the fourth pivot arm 570d at the first end 572d. The fourth pivot arm 570d is operably connected to the elevator car 103 at the second end 574d. The fourth pivot arm 570d may be configured to pivot about or around the second end 574d. The fourth pivot arm 570d is operably connected to the fourth wheel 134d at the intermediate point 576d.

Since the fourth wheel 134d and the fourth linear actuator 534d are operably connected when the fourth linear actuator 534d expands then the fourth wheel 134d will lift away from the second guide beam 111b as the fourth pivot arm 570d pivots at the second end 574d.

It is understood that the linear actuators 534a, 534b, 534c, 534d may be any actuator, such as, for example, a hydraulic actuator, a pneumatic actuator, or any other type of actuator known to one of skill in the art.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the

What is claimed is:

1. An elevator system, the elevator system comprising:
a beam climber system configured to move an elevator car through an elevator shaft by climbing a first guide beam that extends vertically through the elevator shaft, the first guide beam comprising a first surface and a second surface opposite the first surface, the beam climber system comprising:
a first wheel in contact with the first surface; and
a first electric motor configured to rotate the first wheel; and
a wheel decompression system configured to move the first wheel away from the first guide rail.

2. The elevator system of claim 1, wherein the wheel decompression system comprises:
a first backup wheel operably connected to the first wheel such that when the first backup wheel moves away from the first guide beam the first wheel also moves away; and
a first separating cam located between the first guide beam and a first guide rail of the elevator system,
wherein the first separating cam is wedge shaped and configured to move the first backup wheel and the first wheel away from the first guide rail when the first backup wheel rolls onto the separating cam.

3. The elevator system of claim 2, further comprising:
a first axle,
wherein the first electric motor is located on the first axle, and
wherein the first backup wheel is located on the first axle.

4. The elevator system of claim 2, wherein the first separating cam is fixed and wedge shaped.

5. The elevator system of claim 2, wherein the first separating cam further comprises a first end and a second end opposite the first end, the first end having a first thickness and the second end having a second thickness, wherein the second thickness is greater than the first thickness.

6. The elevator system of claim 5, wherein the first backup wheel rolls onto the separating cam at the first end.

7. The elevator system of claim 5, wherein the first separating cam is wedge shaped.

8. The elevator system of claim 2, wherein the first separating cam is adjustable to open and close, and wherein the first separating cam transforms into a wedge shape when opened.

9. The elevator system of claim 8, wherein the first separating cam further comprises a first end and a second end opposite the first end, wherein the first separating cam pivots at the first end to open.

10. The elevator system of claim 1, wherein the beam climber system further comprises: a first compression mechanism configured to compress the first wheel against the first surface.

11. The elevator system of claim 10, wherein the wheel decompression system comprises:
a first expansion wheel operably connected to the first wheel such that when the first expansion wheel moves away from the first guide beam the first wheel also moves away, the first expansion wheel being configured to expand to compress the compression mechanism and push the first wheel away from the first guide beam to relieve pressure on the first wheel.

12. The elevator system of claim 11, further comprising:
a first axle,
wherein the first electric motor is located on the first axle, and
wherein the first expansion wheel is located on the first axle.

13. The elevator system of claim 11, wherein the first expansion wheel further comprises:
a force actuator; and
one or more drum wedges,
wherein the force actuator is configured to actuate to expand the drum wedges to push the first expansion wheel away from the first guide beam.

14. The elevator system of claim 13, wherein the first expansion wheel further comprises:
an engagement sensor configured to detect when the drum wedges are engaged with the first guide beam.

15. The elevator system of claim 10, wherein the wheel decompression system comprises:
a first linear actuator operably connected to the first wheel such that when the linear actuator moves away from the first guide beam the first wheel also moves away, the first linear actuator being configured to expand to compress the compression mechanism and push the first wheel away from the first guide beam to relieve pressure on the first wheel.

16. The elevator system of claim 15, wherein the first linear actuator further comprises:
a first control arm, wherein the first linear actuator is configured to actuate to expand the first control arm to push the first linear actuator away from the first guide beam.

17. The elevator system of claim 15, wherein the wheel decompression system further comprises:
a first pivot arm comprising a first end, a second end located opposite the first end, and an intermediate point located between the first end and the second end; and
a first support bracket operably connected to the first pivot arm at the first end, the first pivot arm being operably connected to the elevator car at the second end, wherein the first pivot arm is operably connected to the first wheel at the intermediate point, and wherein the first pivot arm is configured to pivot about the second end.
